(19) United States
(12) Patent Application Publication
(10) Pub. No.: US 2021/0094491 A1
(43) Pub. Date: Apr. 1, 2021

(54) POWER SUPPLY CONTROL DEVICE, POWER SUPPLY CONTROL METHOD, AND COMPUTER PROGRAM

(71) Applicant: SUMITOMO ELECTRIC INDUSTRIES, LTD., Osaka-shi, Osaka (JP)

(72) Inventor: Tetsuo YAMASHITA, Osaka-shi (JP)

(73) Assignee: SUMITOMO ELECTRIC INDUSTRIES, LTD., Osaka-shi, Osaka (JP)

(21) Appl. No.: 16/980,217

(22) PCT Filed: Dec. 10, 2018
(86) PCT No.: PCT/JP2018/045319

§ 371 Date: Sep. 11, 2020

(30) Foreign Application Priority Data
Mar. 26, 2018 (JP) 2018-057706

(51) Int. Cl. B60R 16/033; G06F 8/65

(52) U.S. Cl. CPC B60R 16/033; G06F 8/65

(57) ABSTRACT

A power supply control device decides, for an on-vehicle control device to which a first power storage device is connected and a second power storage device is connected via a switch, whether or not to use the second power storage device as a power supply for the on-vehicle control device. The power supply control device includes: an acquisition unit configured to acquire an amount of power necessary for the on-vehicle control device to execute an update process for a control program, and a remaining amount of power in the first power storage device; and a decision unit configured to, based on a result of comparison between the necessary amount of power and the remaining amount of power, decide whether or not to use the second power storage device as a power supply for supplying power to the on-vehicle control device that executes the update process.

### TECHNICAL FIELD

The present invention relates to a power supply control device, a power supply control method, and a computer program.

This application claims priority on Japanese Patent Application No. 2018-057706 filed on Mar. 26, 2018, the entire content of which is incorporated herein by reference.

### BACKGROUND ART

In the automotive field in recent years, vehicles have become advanced in functionality, and a diverse range of devices are installed in vehicles. Accordingly, vehicles are equipped with large numbers of control devices, so-called ECUs (Electronic Control Units), for controlling these on-vehicle devices.

Examples of the ECUs include: traveling-related ECUs that control an engine, a brake, an EPS (Electric Power Steering), and the like in response to operations performed on an accelerator, the brake, and a steering wheel; body-related ECUs that control ON/OFF of interior lights and headlights, sound of an alarm unit, and the like in response to switch operations performed by an occupant; and meter-related ECUs that control operations of meters arranged near a driver's seat.

Generally, an ECU consists of an arithmetic processing unit such as a microcomputer, and implements control of a corresponding on-vehicle device by reading out a control program stored in an ROM (Read Only Memory) and executing the control program.

An old version of a control program needs to be overwritten with a new version thereof in response to upgrading of the control program. In addition, data necessary for execution of the control program, such as map information and control parameters, also need to be overwritten.

For example, PATENT LITERATURE 1 discloses a technology (online update function) of downloading an update program via a network, and performing update of a control program of an ECU. In the technology disclosed in PATENT LITERATURE 1, in order to prevent an on-vehicle device from being operated during update of the control program in an ECU, update of the control program is executed when the vehicle is stopped and a user is outside the vehicle.

### CITATION LIST

### Patent Literature

PATENT LITERATURE 1: Japanese Laid-Open Patent Publication No. 2013-2958

### SUMMARY OF INVENTION

A power supply control device according to an aspect of the present disclosure is configured to decide, for an on-vehicle control device to which a first power storage device is connected and a second power storage device is connected via a switch, whether or not to use the second power storage device as a power supply for the on-vehicle control device. The power supply control device includes: an acquisition unit configured to acquire an amount of power necessary for the on-vehicle control device to execute an update process for a control program, and a remaining amount of power in the first power storage device; and a decision unit configured to, based on a result of comparison between the necessary amount of power and the remaining amount of power, decide whether or not to use the second power storage device as a power supply for supplying power to the on-vehicle control device that executes the update process.

A power supply control method according to an aspect of the present disclosure is a method of deciding, for an on-vehicle control device to which a first power storage device is connected and a second power storage device is connected via a switch, whether or not to use the second power storage device as a power supply for the on-vehicle control device. The method includes: acquiring an amount of power necessary for the on-vehicle control device to execute an update process for a control program, and a remaining amount of power in the first power storage device; and deciding, based on a result of comparison between the necessary amount of power and the remaining amount of power, whether or not to use the second power storage device as a power supply for supplying power to the on-vehicle control device that executes the update process.

A computer program according to an aspect of the present disclosure is a computer program for causing a computer to function as a power supply control device configured to decide, for an on-vehicle control device to which a first power storage device is connected and a second power storage device is connected via a switch, whether or not to use the second power storage device as a power supply for the on-vehicle control device. The computer program causes the computer to function as: an acquisition unit configured to acquire an amount of power necessary for the on-vehicle control device to execute an update process for a control program, and a remaining amount of power in the first power storage device; and a decision unit configured to, based on a result of comparison between the necessary amount of power and the remaining amount of power, decide whether or not to use the second power storage device as a power supply for supplying power to the on-vehicle control device that executes the update process.

The present disclosure can be realized not only as a power supply control device provided with such characteristic processing units, a power supply control method including steps of such characteristic processes, and a program that causes a computer to execute such characteristic processes, but also as a semiconductor integrated circuit that realizes a part or the entirety of the power supply control device.

### BRIEF DESCRIPTION OF DRAWINGS

FIG. 1 is a schematic diagram showing a configuration of a vehicle according to an embodiment.

FIG. 2 is a schematic diagram showing an example of a power supply configuration in a vehicle.

FIG. 3 is a block diagram showing an internal configuration of a relay device.

FIG. 4 is a block diagram showing an internal configuration of an ECU.

FIG. 5 is a flowchart showing a flow of a power supply control process executed by a control unit in the relay device.

FIG. 6 is a schematic diagram showing another example of a power supply configuration of a vehicle.

FIG. 7 is a schematic diagram showing still another example of a power supply configuration of a vehicle.

FIG. 8 is a schematic diagram showing yet another example of a power supply configuration of a vehicle.

### DESCRIPTION OF EMBODIMENTS

### Problems to be Solved by the Present Disclosure

An ECU that executes a control program update process needs to be supplied with power. In the vehicle disclosed in PATENT LITERATURE 1, the control program update process is executed in a state where the vehicle is stopped, i.e., where an ignition switch is OFF and supply of power from an ignition power supply is shut off. Therefore, ensuring necessary power is important, depending on the size of the update program or the throughput of the ECU executing the update process.

### Effect of the Present Disclosure

According to the present disclosure, power supply control is executed so as to allow a control program update process to be performed in an on-vehicle control device while a vehicle is stopped.

### Description of Embodiment of the Present Disclosure

Hereinafter, contents of embodiments of the present disclosure are listed and described.

(1) A power supply control device according to an embodiment of the present disclosure is configured to decide, for an on-vehicle control device to which a first power storage device is connected and a second power storage device is connected via a switch, whether or not to use the second power storage device as a power supply for the on-vehicle control device. The power supply control device includes: an acquisition unit configured to acquire an amount of power necessary for the on-vehicle control device to execute an update process for a control program, and a remaining amount of power in the first power storage device; and a decision unit configured to, based on a result of comparison between the necessary amount of power and the remaining amount of power, decide whether or not to use the second power storage device as a power supply for supplying power to the on-vehicle control device that executes the update process.

Thus, when the remaining amount of power in the first power storage device is less than a prescribed amount with respect to the necessary amount of power, the second power storage device can be decided to be the power supply. Therefore, when the remaining amount of power in the first power storage device is insufficient for the necessary amount of power, the second power storage device can be controlled to supply power to the on-vehicle control device. This realizes power supply control that allows the update process to be performed while the vehicle is stopped.

(2) The decision unit may decide not to use the second power storage device as the power supply when the remaining amount of power after the update process is greater than a first threshold value corresponding to the first power storage device, and may decide to use the second power storage device as the power supply when the remaining amount of power after the update process is equal to or smaller than the first threshold value.

Thus, when the remaining amount of power in the second power storage device is sufficient for the necessary amount of power, the second power storage device is decided to be the power supply.

(3) The acquisition unit may further acquire a remaining amount of power in the second power storage device. The decision unit may decide not to use the second power storage device as the power supply when the remaining amount of power, after the update process, in the first power storage device is equal to or smaller than the first threshold value and the remaining amount of power, after the update process, in the second power storage device is equal to or smaller than a second threshold value corresponding to the second power storage device.

Thus, when the update process is performed, power is preferentially supplied from the first power storage device. If the remaining amount of power in the first power storage device is insufficient, power is supplied from the second power storage device.

(4) The acquisition unit may further acquire a remaining amount of power in the second power storage device. The decision unit may decide not to use the second power storage device as the power supply when the remaining amount of power, after the update process, in the first power storage device is equal to or smaller than the first threshold value and the remaining amount of power, after the update process, in the second power storage device is equal to or smaller than a second threshold value corresponding to the second power storage device.

Thus, a burden on a power storage device, which has a less amount of remaining power among the plurality of second power storage devices, can be reduced.

(5) A power supply control method according to an embodiment of the present disclosure is a method to be used in the power supply control device according to any one of the above (1) to (4).

The power supply control method has the same effects as the power supply control devices according to the above (1) to (4).

(6) A computer program according to an embodiment of the present disclosure causes a computer to function as the power supply control device according to any one of the above (1) to (4).

The computer program has the same effects as the power supply control devices according to the above (1) to (4).

Hereinafter, embodiments of the present disclosure will be described with reference to the drawings. In the drawings, the same or corresponding parts are denoted by the same reference signs. The names and functions thereof are also the same. Therefore, descriptions thereof are not repeated. At least some parts of the embodiments described below can be combined together as desired.

### First Embodiment

[Vehicle Configuration]

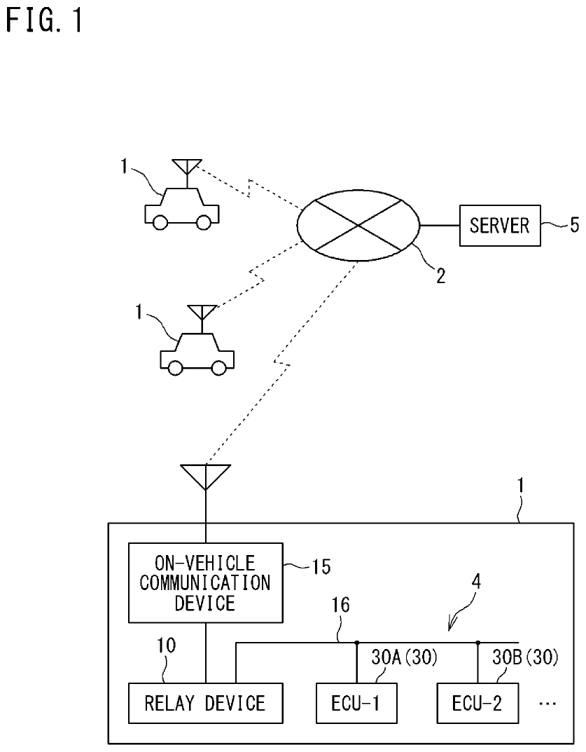

FIG. 1 is a schematic diagram showing a configuration of a vehicle according to a first embodiment.

With reference to FIG. 1, a vehicle 1 according to the present embodiment includes: an on-vehicle communication device 15 for communicating with an external device; a plurality of ECUs (Electronic Control Units) 30A, 30B, . . . ; and a relay device 10 which is an ECU for relaying communications of the plurality of ECUs 30A, 30B, . . . with the external device. The plurality of ECUs 30A, 30B, . . . may be representatively referred to as “ECU 30”.

The respective ECUs 30 are connected to each other by an in-vehicle communication line 16 terminating at the relay device 10, and form an in-vehicle communication network 4 together with the relay device 10. The communication network 4 is a bus-type communication network (e.g., CAN (Controller Area Network)) that allows the ECUs 30 to communicate with each other. In the network of this communication system, information is transmitted/received while being stored in a format called a data frame.

The communication network 4 may adopt not only CAN but also communication standards such as LIN (Local Interconnect Network), CANFD (CAN with Flexible Data Rate), Ethernet (registered trademark), and MOST (Media Oriented Systems Transport: MOST is a registered trademark).

Examples of the ECUs 30 may include: power train-related ECUs that control an engine, a brake, an EPS (Electric Power Steering), and the like in response to operations performed on an accelerator, the brake, and a steering wheel; body-related ECUs that control ON/OFF of interior lights and headlights, sound of an alarm unit, and the like in response to switch operations; and meter-related ECUs that control operations of meters arranged near a driver's seat.

The relay device 10 is further connected to the on-vehicle communication device 15 via a communication line of a predetermined standard. Alternatively, the on-vehicle communication device 15 may be mounted in the relay device 10. The on-vehicle communication device 15 wirelessly communicates with the external device via a wide area network 2 such as the Internet. The external device is, for example, a server 5 which stores therein the update program of the ECU 30. The on-vehicle communication device 15 may have a plug (not shown), and may communicate, via a wire, with an external device connected to the plug. The on-vehicle communication device 15 may be a device such as a mobile phone, a smart phone, a tablet terminal, or a notebook PC (Personal Computer) possessed by the user.

The relay device 10 relays information received from the external device by the on-vehicle communication device 15, to the ECU 30. In addition, the relay device 10 relays information received from the ECU 30 to the on-vehicle communication device 15. The on-vehicle communication device 15 wirelessly transmits the relayed information to the external device.

[Power Supply Configuration of Vehicle]

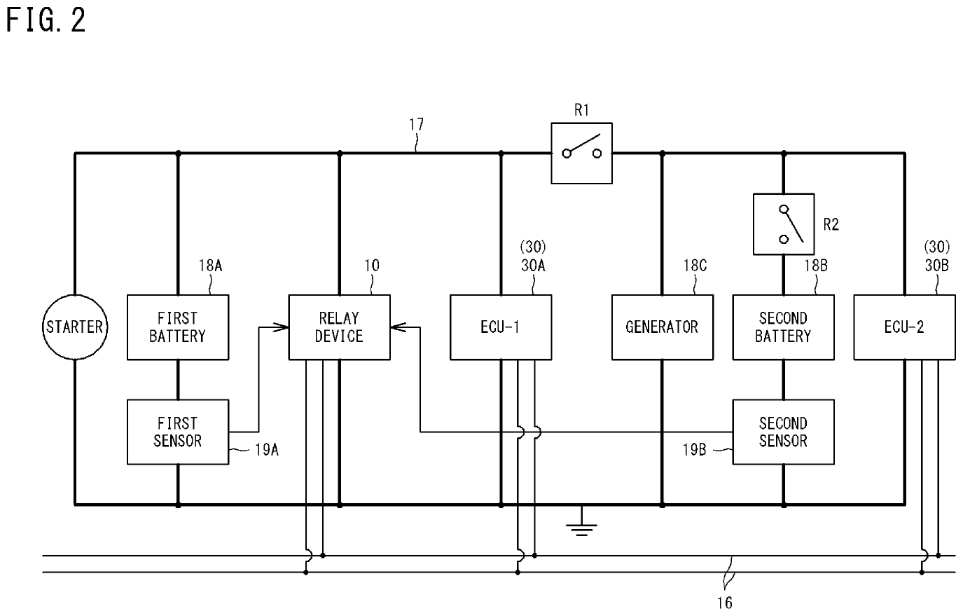

FIG. 2 is a schematic diagram showing an example of a power supply configuration of the vehicle 1. FIG. 2 shows an example of a power supply configuration of a conventional vehicle that is not a hybrid vehicle. With reference to FIG. 2, the vehicle 1 has a plurality of power storage devices. The plurality of power storage devices include a first battery 18A as a main battery and a second battery 18B as a sub battery. The plurality of power storage devices may further include a generator 18C.

In the example shown in FIG. 2, it is assumed that the first battery 18A and the second battery 18B as the plurality of power storage devices are set at the same voltage such as 12 V, for example. Each of the batteries 18A and 18B is generally a lead storage battery. Alternatively, a lithium ion storage battery, a nickel hydrogen battery, or a combination thereof may be adopted. In FIG. 2, a power line 17 is indicated by a thick line to be distinguished from the in-vehicle communication line 16.

An ECU 30A and a starter for starting an engine are connected to the first battery 18A via the power line 17, and power can be supplied from the first battery 18A via the power line 17. The first battery 18A is assumed to supply power mainly to a drive system, and the ECU 30A is, for example, a power supply control ECU or an engine control ECU.

An ECU 30B is connected to the first battery 18A via a first relay R1 which is an example of a switch, and power can be supplied from the first battery 18A via the power line 17 when the first relay R1 is ON (in a relay state).

The ECU 30B is connected to the second battery 18B via a second relay R2 which is an example of a switch, and power can be supplied from the second battery 18B when the second relay R2 is ON. The second battery 18B is supposed to supply power to other power systems via the power line 17, and the ECU 30B is an ECU that controls, for example, interior lights, an air conditioner, door locks, etc.

The ECU 30A is connected to the second battery 18B via the first relay R1 and the second relay R2, and power can be supplied from the second battery 18B via the power line 17 when the first relay R1 and the second relay R2 are ON.

The generator 18C is an alternator, for example. The ECU 30B is connected to the generator 18C, and power generated by the generator 18C can be supplied via the power line 17. The ECU 30A is connected to the generator 18C via the first relay R1, and power generated by the generator 18C can be supplied via the power line 17 when the first relay R1 is ON.

A first sensor 19A and a second sensor 19B, each being a battery sensor, are connected to the first battery 18A and the second battery 18B, respectively. The first sensor 19A and the second sensor 19B are connected to the relay device 10 via communication lines. The first sensor 19A and the second sensor 19B each sense a charge current, a discharge current, a voltage, a temperature, etc., of the corresponding battery. The first sensor 19A and the second sensor 19B may be built in the first battery 18A and the second battery 18B, respectively.

[Configuration of Relay Device]

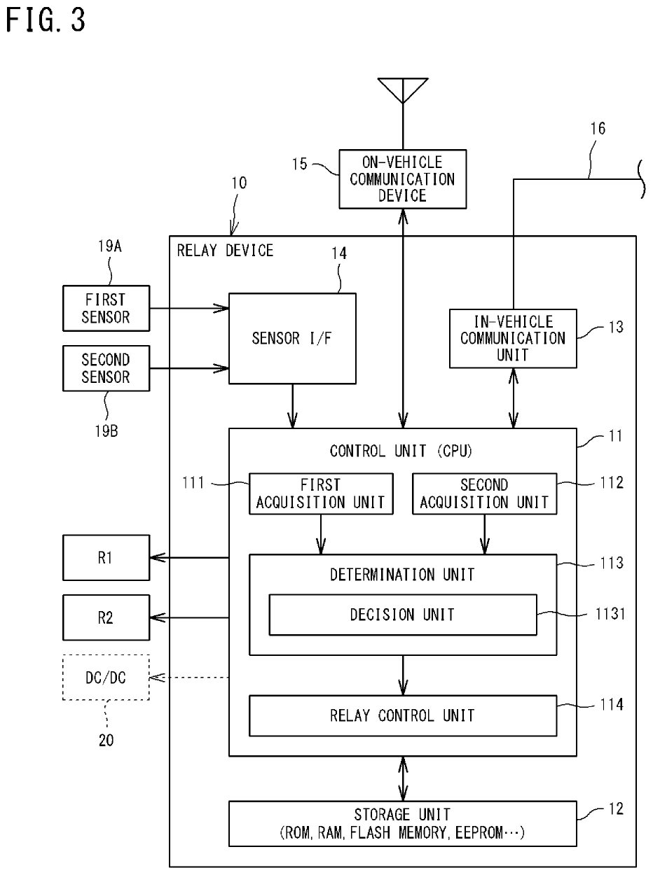

FIG. 3 is a block diagram showing an internal configuration of the relay device 10.

With reference to FIG. 3, the relay device 10 includes a control unit 11, a storage unit 12, an in-vehicle communication unit 13, and a sensor interface (I/F) 14, and the like.

The control unit 11 of the relay device 10 includes a CPU (Central Processing Unit). The CPU in the control unit 11 includes one or a plurality of large scale integrated circuits (LSI). In the CPU including a plurality of LSIs, the LSIs cooperate with each other to realize functions of the CPU. The CPU in the control unit 11 can execute a plurality of programs in parallel by switching between the plurality of programs in a time-sharing manner, for example.

The CPU in the control unit 11 has a function of executing various processes with one or a plurality of programs being read out from the storage unit 12. A computer program to be executed by the CPU in the control unit 11 can be transferred in a state of being recorded in a recording medium such as a CD-ROM or a DVD-ROM, or may be transferred by being downloaded from a computer device such as a server computer.

The storage unit 12 is, for example, a nonvolatile memory element such as a flash memory or an EEPROM (Electrically Erasable Programmable Read Only Memory). The storage unit 12 has a storage area in which programs to be executed by the CPU in the control unit 11, data required in executing the programs, and the like are stored.

The in-vehicle communication line 16 is connected to the in-vehicle communication unit 13. The in-vehicle communication unit 13 is a communication device that communicates with the ECU 30 in accordance with a predetermined communication standard such as CAN.

The in-vehicle communication unit 13 transmits information provided from the CPU in the control unit 11 to a predetermined ECU 30, and the ECU 30 provides information of the transmission source to the CPU in the control unit 11.

The on-vehicle communication device 15 is a wireless communication device including an antenna and a communication circuit that executes transmission/reception of a radio signal from the antenna. The on-vehicle communication device 15 can communicate with the external device when being connected to the wide area network 2 such as a mobile phone network.

The on-vehicle communication device 15 transmits information provided from the CPU in the control unit 11 to the external device such as the server 5 via the wide area network 2 formed by a base station (not shown), and provides information received from the external device to the CPU in the control unit 11.

The first sensor 19A and the second sensor 19B are connected to the sensor I/F 14. The sensors 19A, 19B each input sensing information to the relay device 10. The sensor I/F 14 receives the inputted sensing information, and transfers the sensing information to the control unit 11.

[Internal Configuration of ECU]

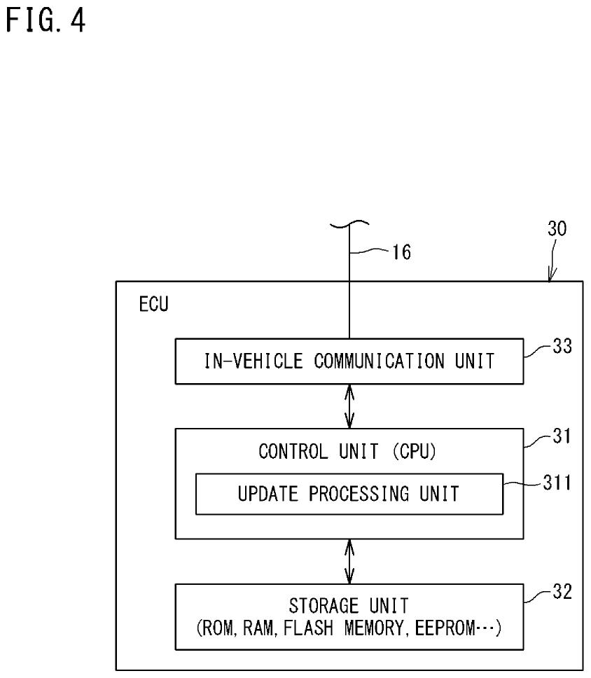

FIG. 4 is a block diagram showing an internal configuration of an ECU 30.

With reference to FIG. 4, the ECU 30 includes a control unit 31, a storage unit 32, an in-vehicle communication unit 33, etc.

The control unit 31 of the ECU 30 includes a CPU. The CPU in the control unit 31 has a function of executing various processes with one or a plurality of programs being read out from the storage unit 32. As this function, the CPU in the control unit 31 includes an update processing unit 311 which is a function of executing a control program update process.

The CPU in the control unit 31 can execute a plurality of programs in parallel by switching between the plurality of programs in a time-sharing manner.

The CPU in the control unit 31 includes one or a plurality of large scale integrated circuits (LSI). In the CPU including a plurality of LSIs, the LSIs cooperate with each other to realize functions of the CPU.

A computer program to be executed by the CPU in the control unit 31 can be transferred in a state of being recorded in a recording medium such as a CD-ROM or a DVD-ROM, or may be transferred by being downloaded from a computer device such as a server computer.

The storage unit 32 is a nonvolatile memory element such as a flash memory, an EEPROM, or a ROM. The storage unit 32 has a storage area in which programs to be executed by the CPU in the control unit 11, data required in executing the programs, and the like are stored.

The in-vehicle communication line 16 is connected to the in-vehicle communication unit 33. The in-vehicle communication unit 33 is a communication device that communicates with the relay device 10 in accordance with a predetermined communication standard such as CAN.

The in-vehicle communication unit 33 transmits information provided from the CPU in the control unit 31 to a predetermined relay device 10, and the relay device 10 provides information of the transmission source to the CPU in the control unit 31.

[Power Supply Control Process]

A control program of each ECU 30 is updated at a predetermined timing. The relay device 10 relays an update program, which has been received from the external device by the on-vehicle communication device 15, to an ECU 30 (hereinafter referred to as “target ECU”) that executes an update process, and instructs the target ECU to execute the update process.

In the present embodiment, the update process is executed while the vehicle 1 is stopped. While the vehicle 1 is stopped, an ignition switch (not shown) is OFF and supply of power from an ignition power supply is shut off. Therefore, the relay device 10 functions as a power supply control device, and the control unit 11 in the relay device 10 executes a power supply control process of supplying necessary power to the target ECU while the update program from the server 5 is retained in the memory.

With reference to FIG. 3, the control unit 11 in the relay device 10 includes a first acquisition unit 111, a second acquisition unit 112, a determination unit 113, and a relay control unit 114 as functions to execute the power supply control process. The determination unit 113 includes a decision unit 1131. These functions are implemented mainly by the CPU in the control unit 11 when the CPU reads out a program stored in the storage unit 12 and executes the program.

The power supply control process includes a first acquisition process, a second acquisition process, and a determination process which are executed by the first acquisition unit 111, the second acquisition unit 112, and the determination unit 113, respectively.

The first acquisition process executed by the first acquisition unit 111 is a process of acquiring an amount of power necessary for the update process in the target ECU (hereinafter referred to as “necessary amount of power”). In order to acquire the necessary amount of power, the first acquisition unit 111 acquires, for example, a memory capacity (writing capacity) necessary for the target ECU to write the update program. The writing capacity may be acquired through calculation based on the size of the update program, or may be acquired through inquiry to the target ECU. The first acquisition unit 111 calculates the necessary amount of power by using the writing capacity. The necessary amount of power is power consumption of a battery, for example. The necessary amount of power is calculated as a battery capacity by multiplying a time which is required for writing in the target ECU and is obtained based on the writing capacity and the writing capability of the target ECU, by power consumption per unit time in the target ECU. The writing capability and the power consumption per unit time of the target ECU may be stored in the relay device 10 in advance, or may be acquired through inquiry to the target ECU.

The second acquisition process executed by the second acquisition unit 112 is a process of acquiring a remaining amount of power of each battery (remaining battery charge). The remaining battery charge is a state of charge (SOC) of the battery, for example. The SOC indicates the ratio of the remaining charge to the full charge capacity. The second acquisition unit 112 acquires a remaining battery charge as sensing information from a sensor corresponding to a target battery. The second acquisition unit 112 may calculate a remaining battery charge by using the sensing information.

The determination process executed by the determination unit 113 includes: a process of determining whether or not the remaining battery charge after the update process satisfies a prescribed amount of power; and a decision process of deciding a battery for supplying power to the target ECU, based on the determination result. The decision unit 1131 executes the decision process. The battery that supplies power to the target ECU is also referred to as a power supply in the following description.

The determination unit 113 stores, in advance, a first power storage device that is a battery connected to the target ECU. When the target ECU is the ECU 30A, the first power storage device corresponds to the first battery. As for the battery being the first power storage device, the determination unit 113 subtracts the necessary amount of power acquired in the first acquisition process from the remaining battery charge acquired in the second acquisition process to obtain a remaining battery charge after the update process. The determination unit 113 stores, in advance, a threshold value for each battery, and determines whether or not the remaining battery charge of the first power storage device after the update process is equal to or smaller than a first threshold value corresponding to the battery.

When the remaining battery charge of the first power storage device after the update process is greater than the first threshold value, the decision unit 1131 decides not to use the second power storage device as the power supply. In other words, the decision unit 1131 decides to use the first power storage device as the power supply.

When the remaining battery charge of the first power storage device after the update process is equal to or smaller than the first threshold value, the determination unit 113 further determines whether or not the remaining battery charge, after the update process, of the second power storage device that is connected to the target ECU via a relay is equal to or smaller than a second threshold value corresponding to this battery. When the target ECU is the ECU 30A, the second power storage device corresponds to the second battery.

When the remaining battery charge of the second power storage device after the update process is greater than the second threshold value, the decision unit 1131 decides to use the second power storage device as the power supply. When there are a plurality of second power storage devices, the determination unit 113 executes the determination on the plurality of second power storage devices in order, and the decision unit 1131, based on each determination result, decides whether or not to use the second power storage device as the power supply.

The relay control unit 114 controls ON/OFF of the first relay R1 and/or the second relay R2 (relay control) according to need, so that power is supplied to the target ECU from the battery that has been decided by the decision unit 1131 to be used as the power supply.

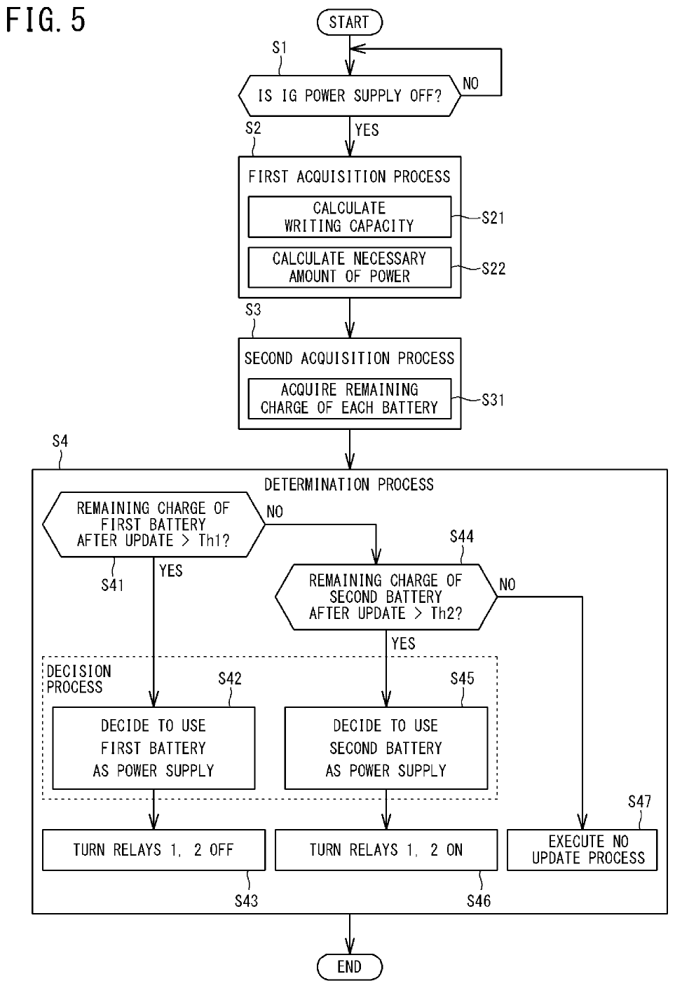

FIG. 5 is a flowchart showing a flow of the power supply control process executed by the control unit 11. The control unit 11 of the relay device 10 executes the process shown in the flowchart of FIG. 5 by reading out a program stored in the storage unit 12 and executing the program. The control unit 11 in the relay device 10 executes the power supply control process when the update program received from the server 5 is retained in the memory. FIG. 5 shows the power supply control process in a case where an ECU-1 (ECU 30A) is a target ECU in the vehicle 1 having the power supply configuration shown in FIG. 2.

With reference to FIG. 5, the control unit 11 confirms that the vehicle 1 is stopped and the ignition power supply is OFF (step S1). When the vehicle 1 is not stopped (NO in step S1), the control unit 11 does not cause the target ECU to execute the update process, and ends the series of processes. In this case, the update program is retained in the memory, and therefore, the power supply control process is repeated at a subsequent timing.

When the vehicle 1 is stopped and the ignition power supply is OFF (YES in step S1), the control unit 11 executes the first acquisition process (step S2). In the first acquisition process in step S2, the control unit 11 calculates a writing capacity C [byte] of the ECU 30A which is the target ECU, based on the size of the update program (step S21). Next, the control unit 11 calculates a necessary amount of power P [Wh] for execution of the update process in the ECU 30A (step S22). In step S22, specifically, the control unit 11 calculates a time t [h] required for writing in the ECU 30A by multiplying the writing capacity C of the ECU 30A by a writing capability that is a time required for writing per unit capacity in the ECU 30A. Then, the control unit 11 calculates the necessary amount of power P [Wh] by multiplying the time t by a power consumption y [W] per unit time of the ECU 30A, which has been stored in advance.

Next, the control unit 11 executes the second acquisition process (step S3). Assuming that a full charge capacity of the first battery 18A is Qa [Ah] and a full charge capacity of the second battery 18B is Qb [Ah], in the second acquisition process in step S3, the control unit 11 acquires remaining battery charges Ca [%], Cb [%], which are SOCs, of the respective batteries, from the sensors 19A, 19B (step S31). In step S31, when the remaining amounts of power in the respective batteries are Ba [Ah] and Bb [Ah], the remaining battery charges are respectively calculated according to Ca=Ba/Qa×100 [%], and Cb=Bb/Qb×100 [%].

The order of the first acquisition process and the second acquisition process is not limited to the above order. The control unit 11 may execute the first acquisition process after the second acquisition process.

Next, the control unit 11 executes the determination process (step S4). In the determination process in step S4, as for the first battery 18A that supplies power to the ECU 30A in a normal state, the control unit 11 subtracts the SOC equivalent to the necessary amount of power P from the remaining battery charge Ca [%] of the first battery 18A, thereby calculating a remaining battery charge LCa [%] after the update process (LCa [%]=Ca [%]−P/12/Qa×100 [%]). Then, the control unit 11 compares the remaining battery charge LCa [%] after the update process with a first threshold value Th1 that is stored for the first battery 18A in advance. Thereafter, based on the comparison result, the control unit 11 executes the decision process of deciding whether or not to use the second battery 18B as the power supply.

When the remaining battery charge LCa [%] is greater than the first threshold value Th1 (LCa>Th1) (YES in step S41), the control unit 11 decides not to use the second battery 18B as the power supply. In this case, the first battery 18A is used as the power supply (step S42). According to the result of the decision process, the control unit 11 executes relay control to set both the first relay R1 and the second relay R2 in the OFF states (step S43).

When the remaining battery charge LCa [%] is equal to or smaller than the first threshold value Th1 (LCa≤Th1) (NO in step S41), the control unit 11 subtracts an SOC equivalent to the necessary amount of power P from the remaining battery charge Cb [%] of the second battery 18B, thereby calculating a remaining battery charge LCb [%] after the update process (LCb [%]=Cb [%]−P/12/Qb×100 [%]). Then, the control unit 11 compares the remaining battery charge LCb [%] after the update process with a second threshold value Th2 of the second battery 18B.

When the remaining battery charge LCb [%] is greater than the threshold value Th2 (LCb>Th2) (YES in step S44), the control unit 11 decides to use, as the power supply, the second battery 18B in addition to the first battery 18A (step S45). According to the result of the decision process, the control unit 11 executes relay control to set both the first relay R1 and the second relay R2 in the ON states (step S46).

When the remaining battery charge LCb [%] is smaller than the threshold value Th2 (LCb≤Th2) (NO in step S44), the control unit 11 decides not to use any of the batteries as the power supply. In this case, the control unit 11 determines to execute no update process in the ECU 30A (step S47). Then, the control unit 11 ends the series of processes without causing the ECU 30A to execute the update process. In this case, since the update program is retained in the memory, the power supply control process is repeated at a subsequent timing.

[Effect of First Embodiment]

Since the relay device 10 functioning as a power supply control device executes the above-described power supply control process, even when the remaining amount of power in the first power storage device is insufficient for the amount of power necessary for the update process in the target ECU, the update process in the target ECU can be performed while the vehicle is stopped by causing the second power storage device to supply power to the target ECU.

### Second Embodiment

The method of calculating the amount of power described in the first embodiment is merely an example, and the present disclosure is not limited to the calculation method. In the above description, an SOC is used as a parameter expressing a remaining battery charge, and a remaining battery charge LCa [%], LCb [%] after the update process is calculated and compared with a threshold values Th1, Th2 for the remaining battery charge. However, the remaining battery charge may be expressed by a parameter other than the SOC. The parameter other than the SOC is, for example, a remaining battery power Ba [Ah], Bb [Ah].

### Third Embodiment

Another example of the determination process is as follows. That is, when the second power storage device consists of a plurality of batteries and at least one of the batteries has a remaining battery charge, after the update process, greater than the second threshold value, a battery whose remaining battery charge after the update process is the greatest among the plurality of batteries may be decided to be used as the power supply. Thus, a burden on the second power storage device whose remaining battery charge is small can be reduced.

### Fourth Embodiment

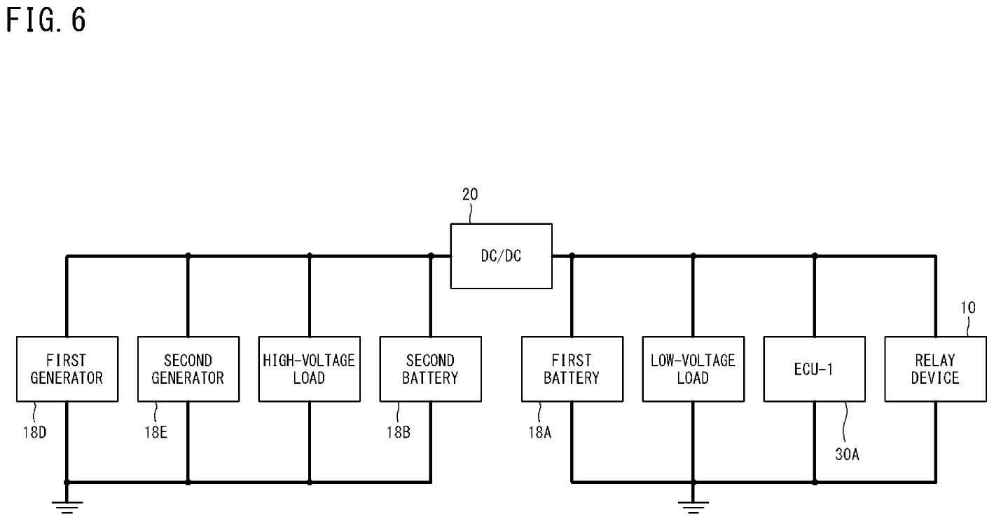

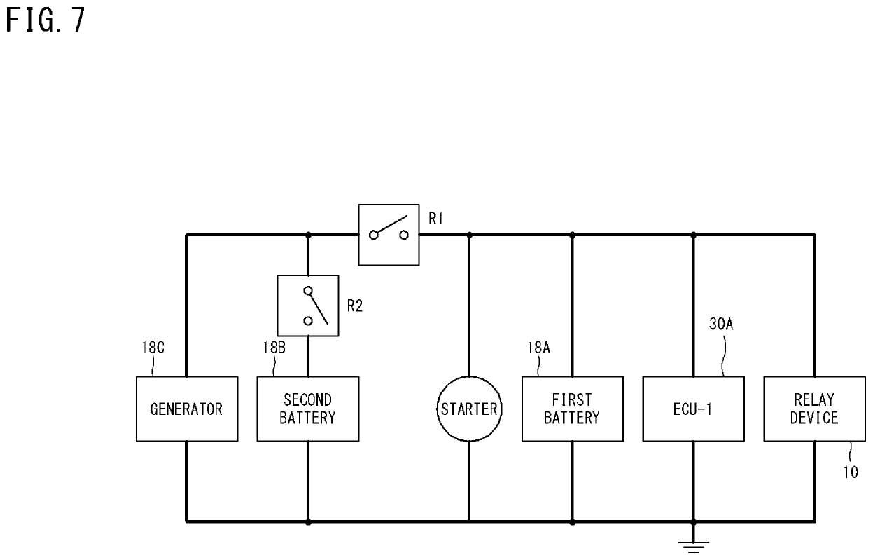

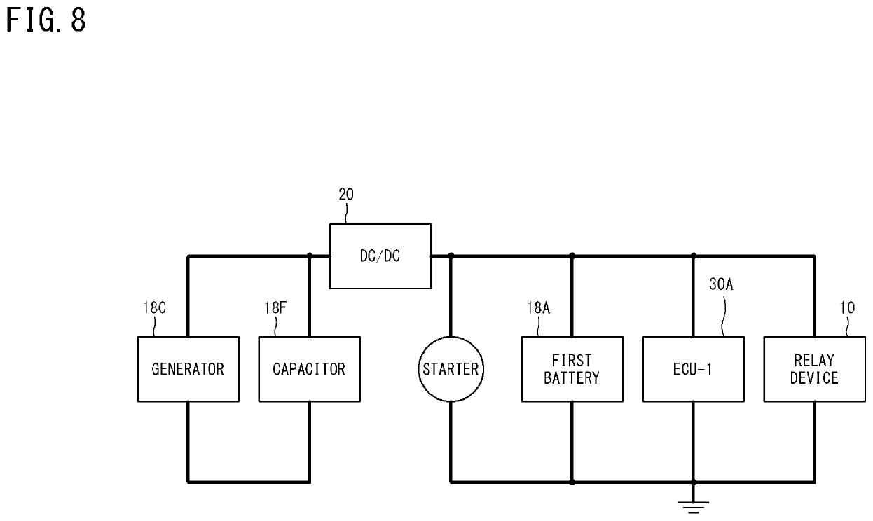

The power supply configuration of the vehicle 1 shown in FIG. 2 is merely an example. The vehicle 1 may be a hybrid vehicle having the power supply configuration shown in FIG. 6, or an engine vehicle having the power supply configuration shown in FIG. 7 or FIG. 8. The function of the relay device 10 as a power supply control device with each power supply configuration will be described.

When the vehicle 1 is a hybrid vehicle, as shown in FIG. 6, a plurality of power storage devices, i.e., a first battery 18A as a low-voltage battery connected to a low-voltage load and a second battery 18B as a high-voltage battery connected to the high-voltage load, are mounted on the vehicle 1, and these batteries are connected to each other via a DC/DC converter 20 as another example of a switch. The plurality of power storage devices may further include a plurality of motor generators such as a first generator 18D and a second generator 18E.

The relay device 10 functioning as a power supply control device controls ON/OFF of the DC/DC converter 20. Therefore, as shown in FIG. 3, the control unit 11 in the relay device 10 further controls the DC/DC converter 20. While the vehicle 1 is traveling, the relay device 10 performs power supply control with the DC/DC converter 20 being in an ON state (activated state). Usually, the relay device 10 sets the DC/DC converter 20 in an OFF state (deactivated state) while the vehicle 1 is being stopped.

When the ECU 30A connected to the first battery 18A is a target ECU and is caused to perform the update process while the vehicle 1 is stopped, the relay device 10 compares the remaining battery charge of the first battery 18A after the update process in the ECU 30A with the first threshold value. When the remaining battery charge of the first battery 18A after the update process is equal to or smaller than the first threshold value, the relay device 10 decides to use the second battery 18B as the power supply. In this case, the relay device 10 turns on the DC/DC converter 20 when the vehicle 1 is stopped, and causes the second battery 18B to supply power to the ECU 30A. Thus, even when the remaining battery charge of the first battery 18A is insufficient for the necessary amount of power for the update process, the update process in the ECU 30A can be performed while the vehicle 1 is stopped.

When the vehicle 1 is an engine vehicle, as shown in FIG. 7, a plurality of power storage devices, i.e., a first battery 18A for supplying power to each load and a second battery 18B, such as a lithium-ion battery, for activating a generator 18C with a motor function, are mounted on the vehicle 1. The first battery 18A and the second battery 18B are connected to the generator 18C via relays R1 and R2, respectively.

The relay device 10 functioning as a power supply control device controls ON/OFF of these relays R1, R2. The relay device 10 turns on at least the second relay R2 when the vehicle 1 is started, i.e., when the motor is activated, to supply power to the generator 18C. Usually, the relay device 10 turns off the relays R1, R2 when the vehicle 1 is traveling and being stopped.

When the ECU 30A connected to the first battery 18A is a target ECU and is caused to execute the update process while the vehicle 1 is stopped, the relay device 10 compares the remaining battery charge of the first battery 18A after the update process in the ECU 30A with the first threshold value. When the remaining battery charge of the first battery 18A after the update process is equal to or smaller than the first threshold value, the relay device 10 decides to use the second battery 18B as the power supply. In this case, the relay device 10 turns on the relays R1, R2 while the vehicle 1 is stopped, and causes the second battery 18B to supply power to the ECU 30A. Thus, even when the remaining battery charge of the first battery 18A is insufficient for the necessary amount of power for the update process, the update process in the ECU 30A can be performed while the vehicle 1 is stopped.

When the vehicle 1 is an engine vehicle, as shown in FIG. 8, a plurality of power storage devices, i.e., a first battery 18A for supplying power to each load and a capacitor 18F for charging power generated in the generator 18C, which is as an alternator that generates power with rotation of the engine, are mounted on the vehicle 1. The first battery 18A is connected to the ECU 30A, and the capacitor 18F is connected to the ECU 30A via a DC/DC converter 20 as an example of a switch.

The relay device 10 functioning as a power supply control device controls ON/OFF of the DC/DC converter 20. Therefore, as shown in FIG. 3, the control unit 11 in the relay device 10 further controls the DC/DC converter 20. When the DC/DC converter 20 is turned on, power charged in the capacitor 18F is supplied to the ECU 30A and the like, and simultaneously, the first battery 18A is charged.

When the ECU 30A connected to the first battery 18A is a target ECU and is caused to execute the update process while the vehicle 1 is stopped, the relay device 10 compares the remaining battery charge of the first battery 18A after the update process in the ECU 30A with the first threshold value. When the remaining battery charge of the first battery 18A after the update process is equal to or smaller than the first threshold value, the relay device 10 decides to use the capacitor 18F as the power supply. In this case, the relay device 10 turns on the DC/DC converter 20, and causes the capacitor 18F to supply power to the ECU 30A. Thus, even when the remaining battery charge of the first battery 18A is insufficient for the necessary amount of power for the update process, the update process in the ECU 30A can be performed while the vehicle 1 is stopped.

### Fifth Embodiment

The power supply control device is not limited to the relay device 10, and may be an ECU that executes power supply control. For example, the power supply control device may be a body-related ECU. Alternatively, the power supply control device may be a dedicated device independent from the relay device 10. The power supply control device may perform the processes up to decision of a battery for supplying power to a target ECU when the update process is executed, and may transfer the decision result to another device and instruct the device to perform relay control. That is, the power supply control device may include the first acquisition unit 111, the second acquisition unit, and the determination unit 113 while the other device may include the relay control unit 114.

The disclosed feature is implemented by one or more modules. For example, the feature can be implemented by: hardware modules such as circuit elements; software modules defining processes that realize the feature; or a combination of the hardware modules and the software modules.

The disclosed feature may be provided as a program, which is a combination of one or more software modules, for causing a computer to execute the aforementioned operations. Such a program may be recorded in a computer-readable recording medium, such as a flexible disc, a CD-ROM (Compact Disk-Read Only Memory), an ROM, an RAM, or a memory card adjunct to the computer, to be provided as a program product. Alternatively, the program may be provided by being recorded in a recording medium such as a hard disk incorporated in the computer. The program may also be provided by being downloaded via a network.

The program according to the present disclosure may call up necessary modules in a predetermined array at a predetermined timing from among program modules provided as a part of an operating system (OS) of a computer, and may cause the computer to execute processing. In this case, the modules are not included in the program itself, and the processing is executed in cooperation with the OS. The program according to the present disclosure also includes such a program including no modules.

The program according to the present disclosure may be provided by being incorporated in a part of another program. In this case as well, modules included in the other program are not included in the program itself, and processing is executed in cooperation with the other program. The program according to the present disclosure also includes such a program incorporated in another program. A program product to be provided is installed in a program storage unit such as a hard disk, and executed. The program product includes the program itself and a recording medium in which the program is recorded.

The above embodiments are merely illustrative in all aspects and should not be recognized as being restrictive. The scope of the present disclosure is defined by the scope of the claims rather than by the description above, and is intended to include meaning equivalent to the scope of the claims and all modifications within the scope.

### REFERENCE SIGNS LIST

1 vehicle

2 wide area network

4 communication network

5 server

10 relay device (power supply control device)

11 control unit

12 storage unit

13 in-vehicle communication unit

14 sensor interface

15 on-vehicle communication device

16 in-vehicle communication line

17 power line

18A first battery (first power storage device)

18B second battery (second power storage device)

18C generator

18D first generator

18E second generator

18F capacitor

19A first sensor

19B second sensor

20 DC/DC converter (switch)

30, 30A, 30B ECU (on-vehicle control device)

31 control unit

32 storage unit

33 in-vehicle communication unit

111 first acquisition unit

112 second acquisition unit

113 determination unit

114 relay control unit

311 update processing unit

1131 decision unit

R1 first relay (switch)

R2 second relay (switch)

Th1 first threshold value

Th2 second threshold value

1. A power supply control device configured to decide a power supply for supplying power to an on-vehicle control device to which a first power storage device is connected, the power supply control device comprising:
an acquisition unit configured to acquire an amount of power necessary for the on-vehicle control device to execute an update process for a control program, and a remaining amount of power in the first power storage device; and
a decision unit configured to, based on a result of comparison between the necessary amount of power and the remaining amount of power, decide whether or not to use a second power storage device as a power supply for supplying power to the on-vehicle control device that executes the update process, the second power storage device being different from the first storage device.

2. The power supply control device according to claim 1, wherein
the decision unit
decides not to use the second power storage device as the power supply when the remaining amount of power after the update process is greater than a first threshold value corresponding to the first power storage device, and
decides to use the second power storage device as the power supply when the remaining amount of power after the update process is equal to or smaller than the first threshold value.

3. The power supply control device according to claim 2, wherein
the acquisition unit further acquires a remaining amount of power in the second power storage device, and
the decision unit decides not to use the second power storage device as the power supply when the remaining amount of power, after the update process, in the first power storage device is equal to or smaller than the first threshold value and the remaining amount of power, after the update process, in the second power storage device is equal to or smaller than a second threshold value corresponding to the second power storage device.

4. The power supply control device according to claim 3, wherein
the second power storage device includes a plurality of power storage devices, and
when the remaining amount of power, after the update process, in the first power storage device is equal to or smaller than the first threshold value and a remaining amount of power, after the update process, in at least one of the plurality of second power storage devices is greater than the second threshold value, the decision unit decides to use, as the power supply, a power storage device whose remaining amount of power after the update process is the greatest among the plurality of second power storage devices.

5. A power supply control method of deciding a power supply for supplying power to an on-vehicle control device to which a first power storage device is connected, the method comprising:
acquiring an amount of power necessary for the on-vehicle control device to execute an update process for a control program, and a remaining amount of power in the first power storage device; and
deciding, based on a result of comparison between the necessary amount of power and the remaining amount of power, whether or not to use a second power storage device as a power supply that supplies power to the on-vehicle control device that executes the update process, the second power storage device being different from the first storage device.

6. A non-transitory computer readable storage medium storing a computer program for causing a computer to function as a power supply control device configured to decide a power supply for supplying power to an on-vehicle control device to which a first power storage device is connected, the computer program causing the computer to function as:
an acquisition unit configured to acquire an amount of power necessary for the on-vehicle control device to execute an update process for a control program, and a remaining amount of power in the first power storage device; and
a decision unit configured to, based on a result of comparison between the necessary amount of power and the remaining amount of power, decide whether or not to use a second power storage device as a power supply for supplying power to the on-vehicle control device that executes the update process, the second power storage device being different from the first storage device.
